(19) United States
(12) Patent Application Publication
(10) Pub. No.: US 2010/0124528 A1
(43) Pub. Date: May 20, 2010

(54) HIGH-STRENGTH COLUMNAR CRYSTAL SILICON PART OF PLASMA ETCHING DEVICE CONSISTING THEREOF

(75) Inventor: Junichi Sasaki, Sanda-shi (JP)

Correspondence Address: EDWARDS ANGELL PALMER & DODGE LLP, P.O. BOX 55874, BOSTON, MA, 02205, US

(73) Assignee: MITSUBISHI MATERIALS CORPORATION, Tokyo (JP)

(21) Appl. No.: 12/452,217

(22) PCT Filed: Aug. 1, 2008
(86) PCT No.: PCT/JP2008/063863

§ 371 Date: Dec. 22, 2009

(30) Foreign Application Priority Data
Aug. 1, 2007 (JP) 2007-200965
Jul. 25, 2008 (JP) 2008-192031

(51) Int. Cl. C01B 33/02

(52) U.S. Cl. 423/348

(57) ABSTRACT

The present invention relates to a columnar crystal silicon having a high strength. In the case where plasma etching device parts such as a focus ring, an upper electrode plate, and a shield ring which are formed from a high-strength columnar crystal silicon ingot having an interstitial oxygen concentration within a range of 1×10¹⁸ to 2×10¹⁸ atms/cm³, it is possible to further increase the diameters of these parts without increasing their thicknesses.

### TECHNICAL FIELD

The present invention relates to a columnar crystal silicon having a high strength, and also relates to plasma etching device parts such as a focus ring, an upper electrode plate, and a shield ring which are formed from the columnar crystal silicon having a high strength.

This application claims priority on Japanese Patent Application No. 2007-200965, filed on Aug. 1, 2007, and Japanese Patent Application No. 2008-192031, filed on Jul. 25, 2008, the contents of which are incorporated herein by reference.

### BACKGROUND ART

Generally, it is necessary to etch a wafer to produce a semiconductor integrated circuit. As a device for etching this wafer, a plasma etching device has been used in recent years. As shown in FIG. 1, this plasma etching device is provided with an upper electrode plate 2 and a vertically movable platform 3 which are spacedly located inside a vacuum chamber 8. The upper electrode plate 2 is insulated from the vacuum chamber 8 by an insulator 13, and is supported by a shield ring 12. Meanwhile, an electrostatic chuck 9 is provided on the platform 3, and a focus ring 1 and a wafer 4 are mounted on the electrostatic chuck 9.

In this plasma etching device, an etching gas 7 is passed through a diffusing member 11. Then, while passing the etching gas 7 through fine through-holes 5 provided in the upper electrode plate 2 towards the wafer 4, a high frequency voltage is applied between the upper electrode plate 2 and the platform 3 by a high frequency power source 6. As a result, a plasma 10 is generated in a space between the upper electrode plate 2 and the platform 3. This plasma 10 impinges on the wafer 4 to etch the surface of the wafer 4. The focus ring 1 and the shield ring 12 serve the role of focusing the generated plasma 10 onto the central portion of the Si wafer 4 and preventing diffusion towards peripheral portions; thereby, a uniform plasma 10 is generated, and thus the Si wafer 4 is uniformly etched.

Conventional types of focus ring 1, upper electrode plate 2, and shield ring 12 are formed of a single crystal silicon, a polycrystal silicon, a columnar crystal silicon, or the like. Among these, the single crystal silicon is most often used (Patent Document 1).

Patent Document 1: Japanese Unexamined Patent Application, First Publication No. 2006-128372

### DISCLOSURE OF THE INVENTION

### Problems to be Solved by the Invention

In recent years, the diameter of the Si wafer 4 to be etched is becoming larger and larger. This involves a need of enlarging the sizes of plasma etching device parts such as the focus ring 1, the upper electrode plate 2, and the shield ring 12. However, in order to form larger sizes of plasma etching device parts such as the focus ring 1, the upper electrode plate 2, and the shield ring 12 from a single crystal silicon ingot, the single crystal silicon ingot needs to have a larger diameter. Moreover, there is a cost to produce a single crystal silicon ingot having such a larger diameter. Furthermore, it is not possible to produce the parts having dimensions larger than certain dimensional levels.

On the other hand, a polycrystal silicon ingot is made by casting silicon, and can be made at a low cost even in the case where its diameter is large. However, a focus ring and a shield ring which are formed from the polycrystal silicon ingot are not preferable because their strengths are low and furthermore, a lot of particles are generated at the time of plasma etching.

Accordingly, recently there is a tendency to make much use of plasma etching device parts such as a focus ring, an upper electrode plate, and a shield ring which are formed from a columnar crystal silicon ingot, and the columnar crystal silicon ingot having a large diameter can be produced at a relatively low cost. However, in conventional types of plasma etching device parts such as a focus ring, an upper electrode plate, and a shield ring, their own weight increases as their size increases. However, their thicknesses must be approximately the same as for the conventional plasma etching device parts such as a focus ring, an upper electrode plate, and a shield ring. Therefore, even though the sizes of plasma etching device parts such as a focus ring, an upper electrode plate, and a shield ring are increased, it is not possible to thicken their thicknesses relatively so as to obtain strength. Accordingly, the strength of the plasma etching device parts such as the focus ring, the upper electrode plate, and the shield ring reduces relatively as their sizes are increased.

### Means to Solve the Problems

Therefore, the inventors of the present invention have conducted studies for developing plasma etching device parts such as a focus ring, an upper electrode plate, and a shield ring which consist of a columnar crystal silicon and have a better strength. As a result, they have obtained following findings. The concentration of interstitial oxygen contained in a columnar crystal silicon has a great influence on the strength of the columnar crystal silicon. Much improved strength is given to a columnar crystal silicon having an increased interstitial oxygen concentration within a range of 1×10¹⁸ to 2×10¹⁸ atms/cm³ which is higher than that of a commercially available columnar crystal silicon (the interstitial oxygen concentration of a commercially available columnar crystal silicon is in a range of 1×10¹⁷ to less than 1×10¹⁸ atms/cm³). In the case where plasma etching device parts such as a focus ring, an upper electrode plate, and a shield ring are formed from such a high-strength columnar crystal silicon ingot having an interstitial oxygen concentration within this range of 1×10¹⁸ to 2×10¹⁸ atms/cm³, it is possible to further increase the diameters of these parts without increasing their thicknesses.

This invention was completed based on the above-mentioned study findings. That is, the present invention provides:

(1) a high-strength columnar crystal silicon having an interstitial oxygen concentration within a range of 1×10¹⁸ to 2×10¹⁸ atms/cm³;
(2) a part of a plasma etching device which consists of the high-strength columnar crystal silicon according to (1) mentioned above;
(3) a high-strength shield ring for plasma etching which consists of the high-strength columnar crystal silicon according to (1) mentioned above;
(4) a high-strength focus ring for plasma etching which consists of the high-strength columnar crystal silicon according to (1) mentioned above; and
(5) a high-strength upper electrode plate for plasma etching which consists of the high-strength columnar crystal silicon according to (1) mentioned above.

The reason why the interstitial oxygen concentration of the high-strength columnar crystal silicon of this invention is limited within a range of 1×10¹⁸ to 2×10¹⁸ atms/cm³ is as follows. In the case where the interstitial oxygen concentration is lower than 1×10¹⁸ atms/cm³, a sufficient transverse strength cannot be obtained, and in the case where the interstitial oxygen concentration exceeds 2×10¹⁸ atms/cm³, it is difficult to produce the columnar crystal silicon having such an interstitial oxygen concentration because oxygen is released in the form of SiO gas during dissolution.

The high-strength columnar crystal silicon of the present invention having an increased interstitial oxygen concentration can be produced by adding silica to a high-purity silicon, melting the mixture thereof in a crucible, and subjecting the melted mixture to unidirectional solidification.

### EFFECTS OF THE INVENTION

The columnar crystal silicon of the present invention having an interstitial oxygen concentration within a range of 1×10¹⁸ to 2×10¹⁸ atms/cm³ has a strength higher than that of a conventional columnar crystal silicon. Therefore, plasma etching device parts such as a focus ring, an upper electrode plate, and a shield ring having much larger diameters can be produced by using this high-strength columnar crystal silicon. As a result, the present invention can greatly contribute to the development of the semiconductor device industry.

### BRIEF DESCRIPTION OF THE DRAWINGS

FIG. 1 is a schematic cross-sectional view of a conventional type of plasma etching device.

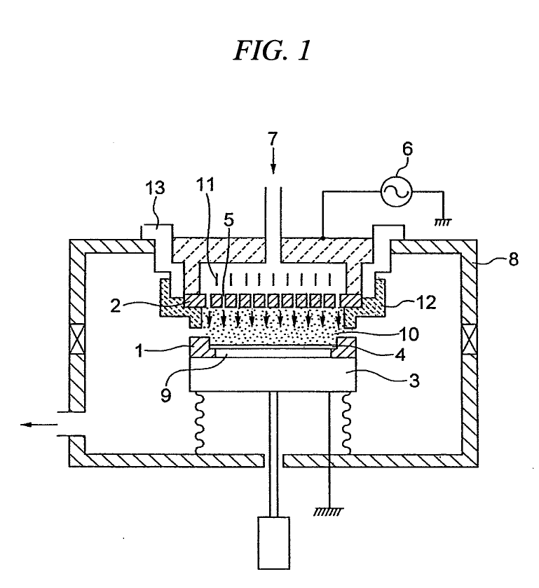

### BRIEF DESCRIPTION OF THE REFERENCE SYMBOLS

1: Focus ring, 2: Upper electrode plate, 3: Platform, 4: Si wafer, 5: Fine through-hole, 6: High frequency power source, 7: Etching gas, 8: Vacuum chamber, 9: Electrostatic chuck, 10: Plasma, 11: Diffusing member, 12: Shield ring, 13: Insulator

### BEST MODE FOR CARRYING OUT THE INVENTION

Commercially available high purity silicon raw material and high purity silica raw material were prepared and blended at ratios shown in Table 1 below. The mixture was melted in a crucible. Then, the obtained molten metal was subjected to unidirectional solidification; thereby, a columnar crystal silicon ingot was formed. This columnar crystal silicon ingot was sliced orthogonally to the growth direction of the columnar crystal of the ingot by using a diamond band saw; thereby, columnar crystal silicon plates of the present invention (product Nos. 1 to 6 in Table 1) and a conventional type of columnar crystal silicon plate (product No. 7) in each thickness of 10 mm were produced.

Furthermore, a commercially available single crystal silicon ingot was cut by using a diamond band saw; thereby, a conventional type of single crystal silicon plate (product No. 8) having a thickness of 10 mm was produced.

Transverse strength test pieces were made from the thus produced columnar crystal silicon plate (product Nos. 1 to 6) of the present invention, conventional type of columnar crystal silicon plate (product No. 7), and conventional type of single crystal silicon plate (product No. 8), and these were subjected to a transverse strength test based on JISZ2248. The results are shown in Table 1.

TABLE 1

| | | Blending composition of | | | |
|---|---|---|---|---|---|
| | | raw materials (% by mass) | | | |
| | Product | High purity | High purity | Interstitial oxygen concentration | Transverse strength |
| Product type | No. | silica | silicon | (×10¹⁸ atms/cm³) | (MPa) |
| Columnar crystal silicon plate | 1 | 0.05 | Balance | 1.0 | 86 |
| of the present invention | 2 | 0.10 | Balance | 1.2 | 87 |
| | 3 | 0.15 | Balance | 1.4 | 90 |
| | 4 | 0.22 | Balance | 1.6 | 92 |
| | 5 | 0.28 | Balance | 1.8 | 94 |
| | 6 | 0.35 | Balance | 2.0 | 97 |
| Conventional type of | 7 | 0 | 100 | 0.8* | 85 |
| columnar crystal silicon plate | | | | | |
| Conventional type of single | 8 | — | | 0.5 | 78 |
| crystal silicon plate | | | | | |

From the results shown in Table 1, the columnar crystal silicon plates (product Nos. 1 to 6) of the present invention were found to have better transverse strengths than those of the conventional type of columnar crystal silicon plate (product No. 7) and the conventional type of single crystal silicon plate (product No. 8).

As mentioned above, while preferred embodiments of the present invention have been described, it should be understood that the present invention is in no way limited by these embodiments. Additions, omissions, substitutions of the construction, and other modifications can be made without departing from the spirit or scope of the present invention. The present invention is not to be considered as being limited by the forgoing description, and is only limited by the scope of the appended claims.

### INDUSTRIAL APPLICABILITY

The present invention relates to a high-strength columnar crystal silicon having an interstitial oxygen concentration within a range of 1×10¹⁸ to 2×10¹⁸ atms/cm³. The high-strength columnar crystal silicon of the present invention has a higher strength than that of a conventional columnar crystal silicon; and therefore, the present invention is able to contribute to the development of the semiconductor device industry.

1. A high-strength columnar crystal silicon having an interstitial oxygen concentration within a range of 1×10¹⁸ to 2×10¹⁸ atms/cm³.

2. A part of a plasma etching device, consisting of the high-strength columnar crystal silicon according to claim 1.

3. A high-strength shield ring for plasma etching, consisting of the high-strength columnar crystal silicon according to claim 1.

4. A high-strength focus ring for plasma etching, consisting of the high-strength columnar crystal silicon according to claim 1.

5. A high-strength upper electrode plate for plasma etching, consisting of the high-strength columnar crystal silicon according to claim 1.
